(19) United States
(12) Patent Application Publication
(10) Pub. No.: US 2011/0020529 A1
(43) Pub. Date: Jan. 27, 2011

(54) Method For Manufacturing Starch Syrup Using Watermelon

(75) Inventors: Ki-ok Park, Jeollabukdo (KR); Jeong-bin An, Jeollabukdo (KR); So-jin An, Jeollabukdo (KR)

Correspondence Address: GARCIA-ZAMOR INTELLECTUAL PROPERTY LAW;ATTN: RUY GARCIA-ZAMOR, 12960 LINDEN CHURCH ROAD, CLARKSVILLE, MD, 21029, US

(73) Assignees: Sunnongwon Agricultural Management Cooperation, Gimje-si (KR); Ki-ok Park, Gimje-si (KR)

(21) Appl. No.: 12/711,253

(22) Filed: Feb. 24, 2010

(30) Foreign Application Priority Data
Jul. 21, 2009 (KR) 10-2009-0066319

(51) Int. Cl. A23L 1/09

(52) U.S. Cl. 426/661

(57) ABSTRACT

Provided is a method for manufacturing starch syrup using watermelon, and more particularly, a new method for manufacturing starch syrup, with respect to storability, processibility, manufacturing economy, productivity, use of additives, etc., which is required to manufacture uniform quality starch syrup which maintains a suitable quality by quantifying the parameters, is constant and stable, and satisfies the palates of average consumers.

The present invention includes a method, including: washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight; placing 100 parts by weight of the watermelon juice separated from the step in a container to simultaneously mix 10 parts by weight of malt and filter residues using a mesh; mixing 50 parts by weight of a hard cooked rice containing glutinous rice and non-glutinous rice with the malt solution and placing the mixture into a thermo pot set at about 50° C. to about 65° C. to ferment the hard cooked rice for about 6 to about 8 hours; squeezing out the liquid of the malt fermented by the hard cooked rice in the step using a mesh, decanting the filtered liquid malt into a pot, and boiling it at about 105° C. to about 115° C. t for about 2.5 to about 3 hours; and heating the liquid malt until the diameters of the boiling surface air bubbles in the boiling step reach about 30 mm and the boiling liquid malt becomes about 85 to about 90 parts by weight and cooling it down to obtain the starch syrup.

### CROSS-REFERENCE TO RELATED APPLICATIONS

This application claims priority under 35 U.S.C. §119 to Korean Patent Application No. 10-2009-0066319, filed on Jul. 21, 2009, the disclosure of which is incorporated herein by reference in its entirety.

### TECHNICAL FIELD

The present disclosure relates to a method for manufacturing starch syrup using watermelon, and more particularly, to a new method for manufacturing starch syrup, with respect to storability, processibility, manufacturing economy, productivity, use of additives, etc., which is required to manufacture uniform quality starch syrup which maintains a suitable quality by quantifying the parameters, is constant and stable, and satisfies the palates of average consumers.

### BACKGROUND

Fruits such as apples, peaches, grapes, etc. are those whose productions are much more than others. Although some of them are used as raw material in beverage or processed food products, most of them are eaten raw. Thus, an efficient way to use these fruits is required. In addition, a lot of fruits must be dumped during the fruit harvest. Although most of the dumped fruits are treated as such due to their poor appearance and are as good as qualified fruits in terms of taste or nutrition, an efficient way to treat the fruits which are to be dumped is required because problems related to their outward appearances and forms prevent the fruits from being distributed.

Thus, methods for reprocessing fruits such as apples, oranges, peaches, apricots, etc. have been widely known. For example, canned products manufactured by separating the juice and flesh of a fruit and vacuum-packaging it are available in the market, and processed foods such as beverage and jam, etc. using the flesh and juice are also commercially available.

Methods for manufacturing starch syrup using fruits based on use values of fruits are known. For example, methods for manufacturing starch syrup including processing non-glutinous rice, processing malt, saccharification, filtration, processing fruits, concentration, etc. are known, and Korean Patent Publication No. 10-1999-0062369 entitled “MANUFACTURING METHOD OF GRAIN SYRUP USING FRUITS FOR HAVING A VARIOUS SHAPE, TASTE, AND SMELL BY USING VARIOUS FRUITS” is disclosed.

Specifically, the manufacturing method of grain syrup includes mixing non-glutinous rice and water at a predetermined ratio and soaking the rice for 12 to 24 hours to swell the rice, followed by steaming the swollen rice using steam at a predetermined temperature for 1 hour; mixing the non-glutinous rice in the step with malt and water, leaving the mixture still at room temperature for 2 to 3 hours, and passing a liquid obtained by roughly extracting malt and water and filtering the mixture into a screen of a mesh to obtain a liquid malt; mixing the swollen steamed rice obtained by the step with the liquid malt obtained by the step to saccharify the mixture for 8 hours while stirring it every hour; extracting the saccharified solution obtained by the step, removing impurities, and centrifuging the solution to obtain a final saccharified solution in which various impurities have been filtered; washing fruits, mixing the fruits with water, heating it, additionally heating the content for 10 min when it begins to boil, and squeezing the content such that a fruit juice may be obtained; heating the saccharified solution obtained by the step to roughly concentration the solution until the sugar content reaches 76 to 77 brix; heating 93 l of concentrated saccharified solution, primarily concentrating it until the sugar content reaches 77 brix, and adding 7 l of a fruit juice into the concentrated solution to secondly concentrate the primarily concentrated saccharified solution until the sugar content reaches 76 to 77 brix; adding an appropriate amount of fruit flavor into the concentrated solution obtained by the step and stirring the mixture uniformly to obtain the starch syrup.

However, a starch syrup of watermelon which is a summertime typical fruit is not only unfamiliar, but also uncommon.

Although methods of manufacturing starch syrup using various fruits has been known in relation to starch syrup manufacturing using fruits as described above, a satisfactory method of manufacturing starch syrup using watermelon among various fruits has not developed. With respect to storability, processibility, manufacturing economy, productivity, use of additives, etc., a new method for manufacturing watermelon jam is required to manufacture an uniform quality starch syrup using watermelon which maintains a suitable quality by quantifying the parameters, is constant and stable, and satisfies the palates of average consumers.

### SUMMARY

Accordingly, with respect to storability, processibility, manufacturing economy, productivity, use of additives, etc. in the manufacture of the starch syrup using watermelon, the present disclosure provides a new method of manufacturing starch syrup using watermelon, which is required to manufacture uniform quality watermelon jam which maintains a suitable quality by quantifying the parameters, is constant and stable, and satisfies the palates of average consumers.

In order to solve the problems and achieve the objects, a method for manufacturing watermelon red pepper paste, includes:

washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;

placing 100 parts by weight of the watermelon juice separated from the step in a container to simultaneously mix 10 parts by weight of malt and filter residues using a mesh;

mixing 50 parts by weight of a hard cooked rice containing glutinous rice and non-glutinous rice with the malt solution and placing the mixture into a thermo pot set at about 50° C. to about 65° C. to ferment the hard cooked rice for about 6 to about 8 hours;

squeezing out the liquid of the malt fermented by the hard cooked rice in the step using a mesh, decanting the filtered liquid malt into a pot, and boiling it at about 105° C. to about 115° C. for about 2.5 to about 3 hours; and

heating the liquid malt until the diameters of the boiling surface air bubbles in the boiling step reach about 30 mm and the boiling liquid malt becomes about 85 to about 90 parts by weight and cooling it down to obtain the starch syrup.

The hard cooked rice is obtained by mixing glutinous rice with non-glutinous rice at, a ratio of 25 parts by weight, respectively, swelling the rice mixture in water for about 3 hours or more, and picking up and placing the swollen rice into an autoclave to cook the rice.

### DETAILED DESCRIPTION OF EMBODIMENTS

Hereinafter, preferred embodiments of the present invention will be described in detail.

In describing the present invention, detailed description about related known functions or structures will be omitted if the detailed description may unnecessarily obscure the substance of the present invention.

A method for manufacturing starch syrup according to a preferred embodiment of the present invention may be provided in the following manner.

A starch syrup may be manufactured by washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight; placing 100 parts by weight of the watermelon juice separated from the step in a container to simultaneously mix 10 parts by weight of malt and filter residues using a mesh; mixing 50 parts by weight of a hard cooked rice containing glutinous rice and non-glutinous rice with the malt solution and placing the mixture into a thermo pot set at about 50° C. to about 65° C. to ferment the hard cooked rice for about 6 to about 8 hours; squeezing out the liquid of the malt fermented by the hard cooked rice in the step using a mesh, decanting the filtered liquid malt into a pot, and boiling it at about 105° C. to about 115° C. for about 2.5 to about 3 hours; and heating the liquid malt until the diameters of the boiling surface air bubbles in the boiling step reach about 30 mm and the boiling liquid malt becomes about 85 to about 90 parts by weight and cooling it down to obtain the starch syrup.

The hard cooked rice is preferably obtained by mixing glutinous rice with non-glutinous rice at a ratio of 25 parts by weight, respectively, swelling the rice mixture in water for about 3 hours or more, and picking up and placing the swollen rice into an autoclave to cook the rice. When only non-glutinous rice was used to prepare and ferment a hard cooked rice and then a liquid malt was boiled, the peculiar unpleasant odor of the rice emitted. When only glutinous rice was used to prepare and ferment a hard cooked rice and then a liquid malt was boiled, the peculiar color of a watermelon starch syrup had deteriorated. However, when non-glutinous rice and glutinous rice were used at a ratio of 1:1 to prepare and ferment a hard cooked rice and then a liquid malt was boiled, the unpleasant odor had been reduced and the peculiar color of watermelon was maintained.

In the boiling step, when the diameters of the surface air bubbles in the liquid malt reach about 30 mm, the concentration of the starch syrup which had been boiled down while moisture was evaporated by heat had become about 60% to about 70%. As the amount of moisture evaporated increases, the diameters of the air bubbles gradually become bigger and the concentration increases. The concentration of starch syrup must be maintained at an appropriate level because it is not desirable when it is too thin or thick. It was confirmed that the starch syrup was proper to use when the concentration was about 60% to about 70%. It was also confirmed in the boiling step that the concentration level was obtained when the diameters of the air bubbles reach about 30 mm. The sizes of the air bubbles were confirmed in the boiling step of the manufacturing process and a starch syrup at an appropriate concentration may be manufactured.

A starch syrup is manufactured by a method for manufacturing starch syrup using watermelon according to the present invention, including: a pretreatment step, a fermentation step of watermelon juice, a liquid malt, water, and a hard cooked rice containing non-glutinous rice and glutinous rice, a saccharification step of heating ingredients from watermelon juice, a liquid malt, water, and a hard cooked rice containing non-glutinous rice and glutinous rice, and a concentration step of the ingredients.

The ingredient analysis results of a starch syrup using watermelon manufactured according to the present invention are summarized in the following <Table 1>.

TABLE 1

| Item | Result | Item | Result |
|---|---|---|---|
| Calories | 269.70/100 g | Saturated fat | 0.0 g/100 g |
| Carbohydrate | 66.12 g/100 g | Trans fat | 0.0 g/100 g |
| Moisture | 31.00% (±0.40) | Cholesterol | 0.0/100 g |
| Ash | 0.53% (±0.01) | Sugars | 44.90 g/100 g |
| Crude protein | 2.25 g/100 g (±0.04) | Crude fiber | 4.43% (±0.03) |
| Crude fat | 0.1% (±0.01) | | |

The color of starch syrup may be expressed as a peculiar color of watermelon. Although the tastes and flavors were different depending on the amounts of a liquid malt, non-glutinous rice and glutinous rice used as additives, it was confirmed that the syrup contained a sufficient amount of watermelon flavor and the taste of the syrup was soften by natural sugars such as glucose and fructose, and amino acid ingredients. It was also confirmed that the starch syrup contained the peculiar taste and flavor of watermelon which may not be obtained from other fruits.

The starch syrup using watermelon concentrated at a proper level from evaporation of moisture has excellent storability for a long time and is economical due to a low-cost manufacture by a relatively simple manufacturing process. The starch syrup may be mass produced due to the excellent productivity. With respect to use of additives, etc., a uniform quality starch syrup using watermelon, which maintains a suitable quality by quantifying the parameters, is constant and stable, and satisfies the palates of average consumers may be obtained. The taste and flavor may be enhanced by amino acids and lycopene contained in watermelon ingredients, and thus the starch syrup may be widely used for the improvement and enhancement of the health by appropriate combination with watermelon ingredients.

The present invention may mass-produce a starch syrup using watermelon, which is excellent in storability because it does not spoil and may be stored for a long time in the manufacture of the starch syrup using watermelon. The present invention also provides an excellent processibility by quantifying materials in the boiling process after the extracting process of watermelon juice and fermenting process of a hard cooked rice containing non-glutinous rice and glutinous rice, and may contribute to the commercialization of starch syrup using watermelon by mixing glutinous rice with non-glutinous rice which is required for saccharification as an additive and commonly used to maintain the concentration to manufacture a starch syrup using watermelon, which is constant in taste and flavor and easy to eat.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A method for manufacturing starch syrup using watermelon, comprising:
washing the surface of a watermelon and collecting the seeds, separating 100 parts by weight of the edible portion from the rind portion of the watermelon, grinding it into particles, placing the ground edible portion in a container to allow the fruit flesh and the fruit juice to float and precipitate, respectively, and separate the flesh and juice by using a mesh for filtration such that the floating flesh is 40 parts by weight of the and the juice is 60 parts by weight;
placing 100 parts by weight of the watermelon juice separated from the step in a container to simultaneously mix 10 parts by weight of malt and filter residues using a mesh;
mixing 50 parts by weight of a hard cooked rice containing glutinous rice and non-glutinous rice with the malt solution and placing the mixture into a thermo pot set at about 50° C. to about 65° C. to ferment the hard cooked rice for about 6 to about 8 hours;
squeezing out the liquid of the malt fermented by the hard cooked rice in the step using a mesh, decanting the filtered liquid malt into a pot, and boiling it at about 105° C. to about 115° C. for about 2.5 to about 3 hours; and
heating the liquid malt until the diameters of the boiling surface air bubbles in the boiling step reach about 30 mm and the boiling liquid malt becomes about 85 to about 90 parts by weight and cooling it down to obtain the starch syrup.

2. The method of claim 1, wherein the hard cooked rice is obtained by mixing glutinous rice with non-glutinous rice at a ratio of 25 parts by weight, respectively, swelling the rice mixture in water for about 3 hours or more, and picking up and placing the swollen rice into an autoclave to cook the rice.
